(19) United States
(12) Patent Application Publication
(10) Pub. No.: US 2004/0034559 A1
(43) Pub. Date: Feb. 19, 2004

(54) Method and system for providing web-based marketing

(76) Inventors: Michele J. Harris, New York, NY (US); Stephan J. Sebbag, New York, NY (US)

Correspondence Address: Paul D. Amrozowicz, Esq., Quarles & Brady Streich Lang LLP, Renaissance One, Two N. Central Avenue, Phoenix, AZ, 85004-2391, US

(21) Appl. No.: 09/748,393

(22) Filed: Feb. 12, 2001

(51) Int. Cl. G06F 17/60

(52) U.S. Cl. 705/14; 709/218

(57) ABSTRACT

An online publisher server computer including a content-based website stored in memory, and an online advertiser server computer including a marketing-based website stored in memory, are each provided. Web pages of the content-based website are formatted to be displayed from the online publisher server computer in a first region of a client computer browser display screen. Web pages of the marketing-based website are formatted to be displayed from the online advertiser server computer in a second portion of the client computer browser display screen. A homepage of the content-based website is transmitted from the online publisher server computer for display in the client computer browser display screen. In response to a user selecting a hyperlink displayed on the homepage of the content-based website, the formatted web pages of the content-based website are transmitted from the online publisher server computer for display in the first region of the client computer browser display screen and, simultaneously and independently, the formatted web pages of the marketing-based website are transmitted from the online advertiser server computer for simultaneous and independent display in the second region of the client computer browser display screen.

### BACKGROUND

1. Field of the Invention

The present invention relates to marketing over a computer driven communications network. More specifically, the present invention relates to a system and method for providing marketing via the Internet, and more particularly, via the World Wide Web (“the web”).

2. Description of Related Art

Internet use has exploded over the past several years. Statistical demographics indicate that people with Internet access, though somewhat concentrated in certain age groups, is widespread and used by people from myriad demographic categories. Thus, it is not surprising that the Internet, via the user access readily provided by the web, has spawned a new genre of business, known colloquially as “e-commerce.”

E-commerce, which is the acronym used for “electronic commerce,” generally describes any form of business that is conducted via the Internet. The businesses taking advantage of this new business genre include both content providers and product marketers. Content providers are companies that have websites that include one or more web pages that provide various types of published information. These so-called online publishers are akin to the publishers that people come across every day. For example, both CNN and Sports Illustrated each have websites that provide content related to news, sports, weather, and finances, to name just a few topics. The online product marketers are companies that have websites that include one or more web pages that allow web users to purchase various goods and/or services via the Internet. For example, Amazon.com and Barnes & Noble each have websites that allow users to, among other things, purchase books safely and securely via the web. Online product marketers are also companies that have websites that include one or more web pages that provide brand and/or product awareness for goods and services sold in the traditional lines of commerce. Examples of this type of online product marketer include BMW and Procter & Gamble, each of which have websites directed mainly to enhancing brand and product awareness.

Although, as noted above, Internet access and use continues to increase, the online publishing world continues to be faced with the task of deriving revenue to maintain the publishing websites financially viable. Moreover, while some online product marketing companies are finding that product sales via the web are increasing, others are facing financial difficulty.

The financial success of content providers and product marketing companies in the traditional channels of commerce is derived, in part, from successful marketing/advertising schemes. The purpose of advertising is, of course, to generate brand awareness and thereby drive purchasers into stores to purchase specific goods and/or services. Most, if not all, of this advertising occurs in the traditional mass media publishing channels, including the print media, and radio and television broadcast media. Most companies find this form of advertising/marketing to be successful and are, therefore, willing to purchase advertising space and/or air time from the traditional content provider. The success of this type of advertising is attributed, at least in part, to the fact that the audience for these media is a passive one that is receptive to advertising. For example, readers of print media see all sorts of advertising while reading their favorite newspaper or magazine, television viewers see and hear all sorts of advertisements while watching their favorite programs, and radio listeners hear all sorts of advertisements while listening to their favorite station. The bottom line is, because this form of advertising is successful, both publishers and marketers reap financial reward from the sale and use of advertising space and/or time.

Presently, online publisher revenue models are directed at the use of subscription sales, peripheral product sales, syndication, and so-called “banner advertising.” Subscription sales have not been successful because most Internet users are reluctant to pay for content published over the Internet. Product sales do not make up the difference, because this is typically not the core of the online publisher's business. Syndication is not the answer either, since online publishers cannot command sufficiently high prices for the content. Online publishers are also finding that banner advertising is failing to provide the needed revenue. This is because online marketers have discovered that banner ads do not provide the same success as traditional advertising/marketing schemes. Therefore, online product marketers are driving down the price of such ads.

Most web users are familiar with banner ads. Typically, these ads appear at the top of an online publisher's website and attempt to draw a user's attention. The goal, of course, is that the user will see the ad and click on it with a computer mouse or similar device. Once the user clicks on the ad, the user is transported to the advertiser's marketing website. This action is known as a “click-through.” Unfortunately, the active Internet user tends to ignore banner ads, rather than clicking through to the advertiser's marketing website. Indeed, statistics indicate that click-through rates have steadily declined over the past few years, and have decreased from about 1% in 1999 to less than 0.5% currently.

Because click-through rates are so low, advertisers/marketers are finding that the cost of such advertising is far too high for the return on investment. As a result, online publishers are finding it difficult to sell advertising to online marketers, and are facing financial difficulties. Moreover, because the present online advertising models are not creating the necessary brand awareness to drive online consumers to online marketer's websites, online marketers are also facing the prospect of financial morass.

Hence, there is a need in the art for a method and system of providing a marketing scheme via the web that addresses the current inefficiencies faced by both the content provider and marketing industries in the online marketplace.

### SUMMARY OF THE INVENTION

The present invention is a method and system for providing web-based marketing by simultaneously and independently displaying formatted first and second web pages in first and second regions, respectively, of a single user computer browser display screen. In one aspect of the present invention, an online publisher server computer including a content-based website stored in memory, and an online advertiser server computer including a marketing-based website stored in memory, are each provided. Web pages of the content-based website are formatted to be displayed from the online publisher server computer in a first display region of a client computer browser display screen. Web pages of the marketing-based website are formatted to be displayed from the online advertiser server computer in a second display region of the client computer browser display screen. A homepage of the content-based website is transmitted from the online publisher server computer for display in the client computer browser display screen. Then, in response to a user selecting a hyperlink displayed on the homepage of the content-based website, the formatted web pages of the content-based website are transmitted from the online publisher server computer for display in the first display region of the client computer browser display screen and, simultaneously and independently, the formatted web pages of the marketing-based website are transmitted from the online advertiser server computer for simultaneous and independent display in the second display region of the client computer browser display screen.

In another aspect of the present invention, an online publisher server computer including a content-based website stored in memory, and an online advertiser server computer including a marketing-based website stored in memory, are each provided. Web pages of the content-based website are formatted to be displayed from the online publisher server computer in a first display region of a client computer browser display screen. Web pages of the marketing-based website are formatted to be displayed from the online advertiser server computer in a second display region of the client computer browser display screen. Then, in response to a user navigating to a URL of the content-based website, the formatted web pages of the content-based website are transmitted from the online publisher server computer for display in the first display region of the client computer browser display screen and, simultaneously and independently, the formatted web pages of the marketing-based website are transmitted from the online advertiser server computer for simultaneous and independent display in the second display region of the client computer browser display screen.

The present invention provides for the simultaneous and independent transmission and display of web pages from two independent websites in a single browser display screen. Thus, the user can independently navigate through each web page, and other webpages associated with the same website. The user can, if desired, increase or decrease the display size of one of the displayed web pages without affecting the transmission state of other web page.

The present invention provides significant features and advantages over known web-based marketing systems and methods. For instance, because the present system drives consumers directly to the active advertiser's websites, the invention provides advertisers with a more cost effective marketing scheme. Essentially, with the present invention, online advertisers can realize 100% click-through, rather than the present 0.05% click-through rate associated with ad banner technology.

Moreover, because of the above-noted features and advantages from an online advertiser viewpoint, the present invention provides online advertisers with a more effective, profitable model for content delivery that will yield higher financial returns than present ad banner technology.

### BRIEF DESCRIPTION OF THE DRAWINGS

FIG. 1 illustrates an embodiment of a system according to the present invention in which the method of the present invention can be practiced;

FIGS. 2A and 2B together illustrate an example of the layout of computer browser display screens that result from use of the present invention;

FIG. 3 illustrates an architectural flowchart depicting the interaction of the system while practicing the method of the present invention;

FIG. 4 is a flowchart depicting the steps for carrying out a method according to the present invention;

FIG. 5 is a flowchart depicting the steps for carrying out a method according to an alternative embodiment of the present invention;

FIG. 6 is a flowchart depicting the steps for carrying out a method according to yet another alternative embodiment of the present invention;

FIG. 7 is a partial flowchart depicting detailed steps associated with a method for displaying one or more marketing-based web pages according to one embodiment; and

FIG. 8 is a partial flowchart depicting detailed steps associated with a method for displaying one or more marketing-based web pages according to an alternative embodiment.

### DETAILED DESCRIPTION OF THE INVENTION

Before proceeding to a detailed description, some preliminary connotational matters will first be addressed. Specifically, throughout the description, the use of the terms “online publisher ” and “online advertiser” will be repeatedly used. This is because the preferred embodiment of the present invention is directed to the web-based marketing/advertising environment, encompassing both online publishers and online advertisers. However, it is to be expressly understood that the present invention is not necessarily limited to this environment. Rather, the present invention encompasses any online/web-based environment where it is desirable to display two or more websites simultaneously and independently from two or more web servers.

“Formatted web pages”, in the context of the present invention, refers to web pages that are designed to be displayed in specific display regions of a single computer browser display screen. Moreover, the term “online publisher,” as used herein, refers to any entity having a hosted website that is primarily directed at providing published content via the Internet. The term “online advertiser,” as used herein, refers to any entity having a hosted website that is primarily directed at selling goods and/or services, or for merely generating brand awareness via the Internet. Again, these terms are used solely in the context of a preferred embodiment, and the present invention should not be limited to these contexts. Indeed, the present invention encompasses any relationship, business or otherwise, where it is desirable to display two or more websites simultaneously and independently from two or more web servers.

Finally, while it is recognized that there is a technological distinction between the Internet and the World Wide Web, the terms are used seemingly interchangeably throughout this description. The use of these terms in this fashion is for descriptive convenience only. The skilled artisan will appreciate that the present invention encompasses the technological context of both the Internet and World Wide Web.

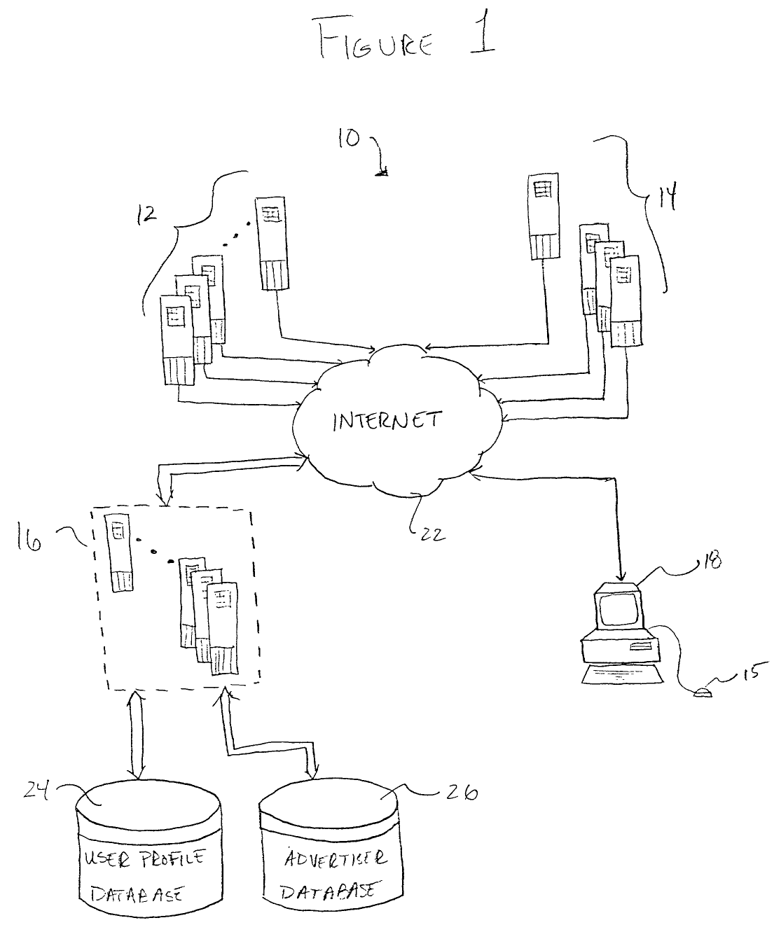

Turning now to a description of the present invention, one embodiment of a system 10 for carrying out the invention is illustrated in FIG. 1. The system 10 includes one or more online publisher servers 12, one or more online advertiser servers 14, one or more redirect servers 16, and one or more user computers 18, all communicating via the Internet 22 using standard, generally known data exchange techniques, such as the TCP/IP protocol.

The online publisher servers 12 and online advertiser servers 14 each include a website stored in unillustrated memory, with each website including one or more formatted web pages. web page that links the user computer 18 to the online publisher's homepage 32. As is known in the art, hyperlinks displayed on a web page transfer the user computer 18 to a different web page when selected by the user viewing the web page. This different web page may be another web page within the same website, or may be a web page from another website altogether. As is also known, the hyperlink to the online publisher's homepage 32 may be included as part of an e-mail message displayed by the user computer 18. In either of these additional non-limiting cases, when the user selects the hyperlink, the user computer 18 is directed to the online publisher's homepage 32, and the remaining portions of the method, which will now be described, are carried out.

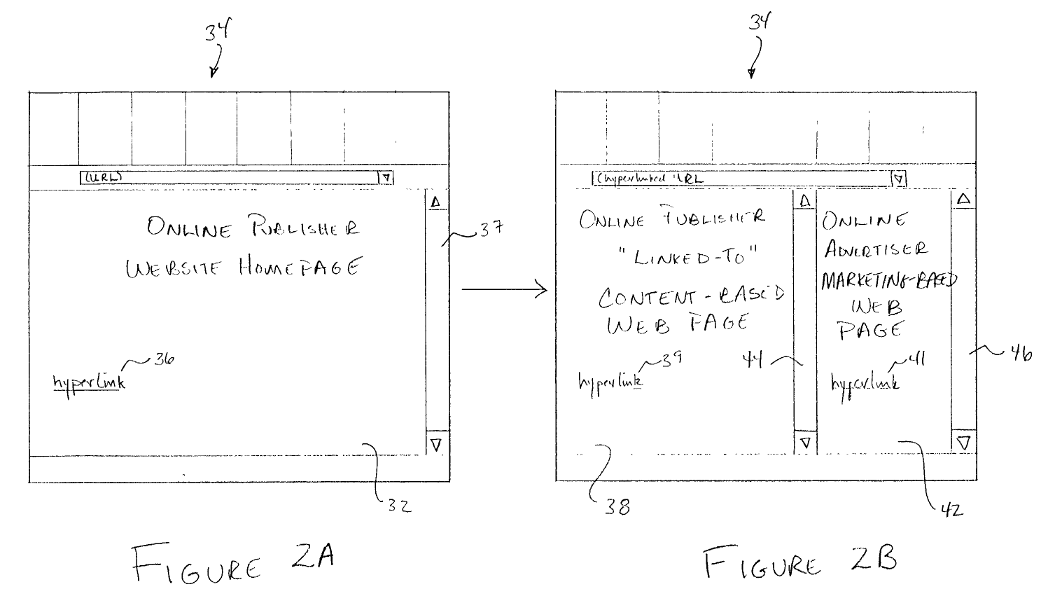

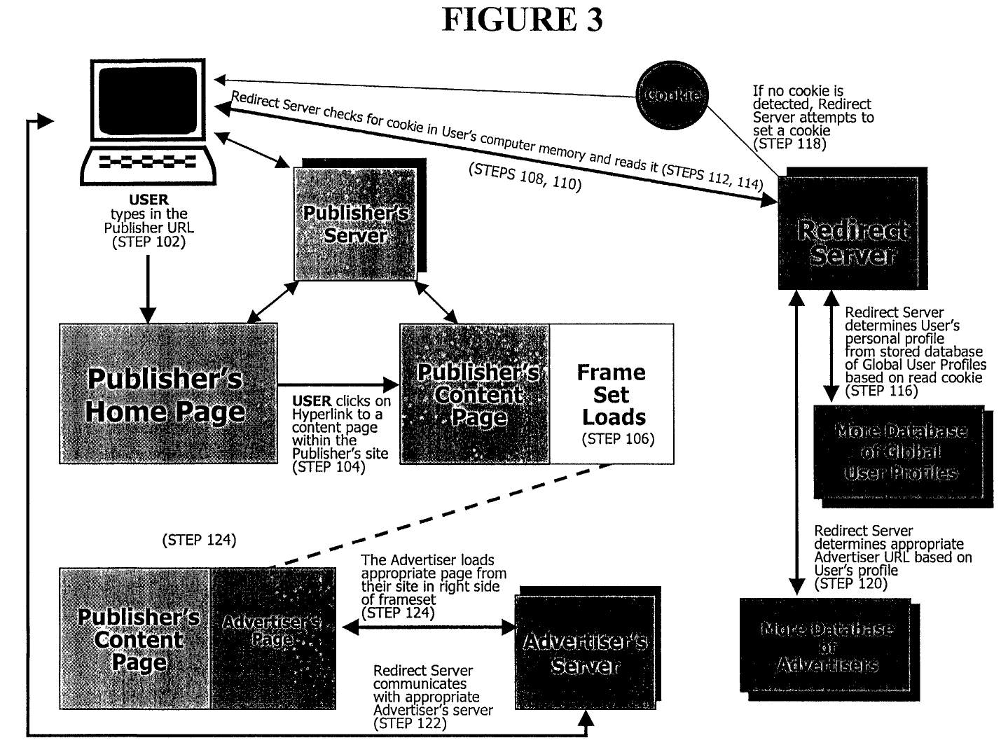

Returning now to FIGS. 2A and 2B, once the homepage 32 is displayed the user can navigate up and down the homepage 32, if necessary, using the displayed “scroll bar” 37. The online publisher homepage 32 also contains numerous hyperlinks 36. With the present invention, when the user selects a hyperlink 36 on the homepage 32 of a content-based website, using a mouse or any known input device 15 (see FIG. 1), the user computer browser display screen 34 simultaneously and independently displays formatted web pages from two different websites in a split-screen format. One of the formatted web pages that is displayed is the one associated with the selected hyperlink 36, and the other formatted web page that is displayed is one that is not associated with the selected hyperlink 36. More specifically, the computer browser display screen 34 simultaneously and independently displays a content-based web page 38 associated with the selected hyperlink 36 from the online publisher server 12, and a formatted marketing-based web page 42 from one of the online advertiser servers 14, as depicted in FIG. 2B. Preferably, the two formatted web pages 38, 42 are divided on the display screen 34 by a scrolling bar 44, for navigating up and down the formatted content-based web page 38, while the formatted marketing-based web page 42 includes its own scroll bar 46. Preferably, though certainly not so limited, the display ratio of the formatted content-based web page 38 to the formatted marketing-based web page 42 is about 60/40. In other words, the formatted content-based web page 38 will cover approximately 60% of the display screen 34, with the remaining approximately 40% being covered by the marketing-based web page 42. Importantly, because both formatted web pages 38, 42 are transmitted to the user computer 18 independently from

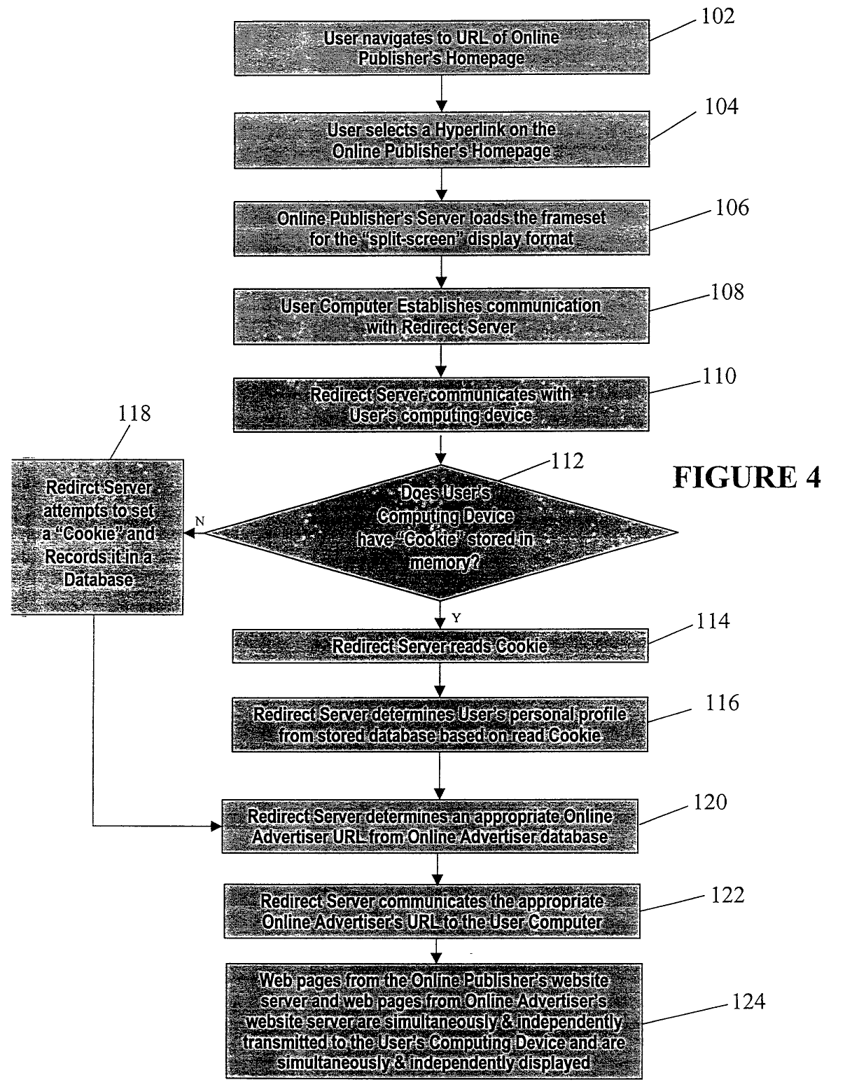

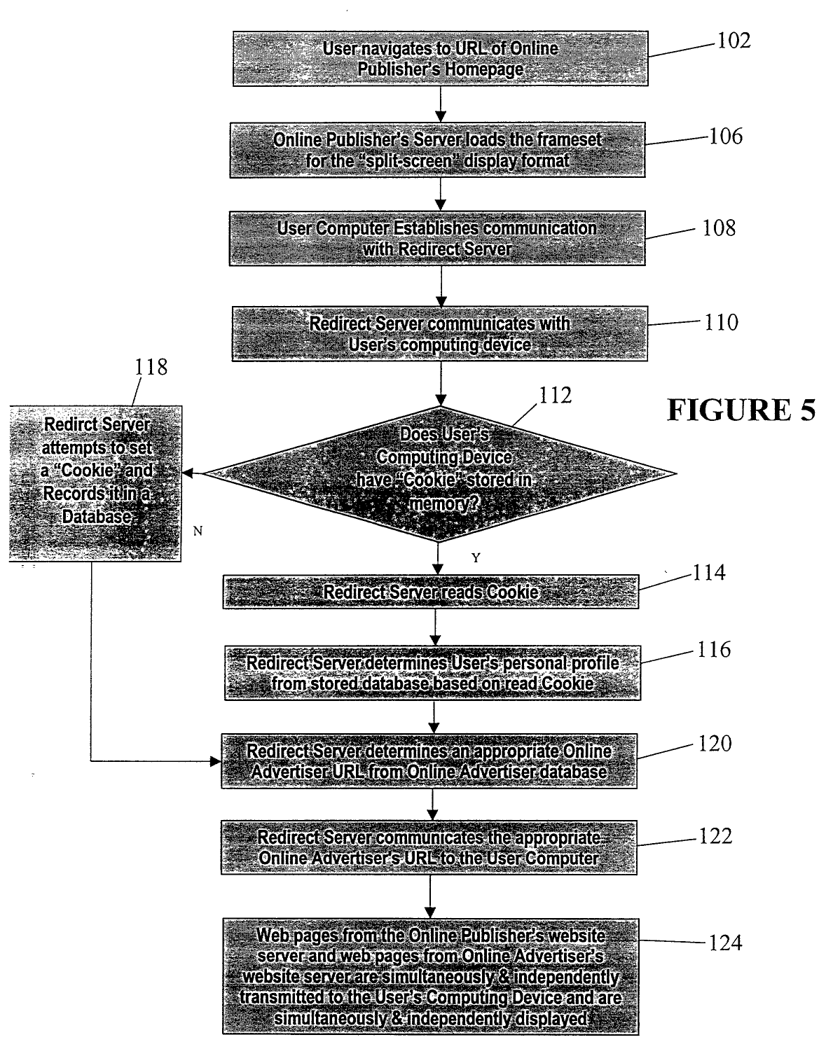

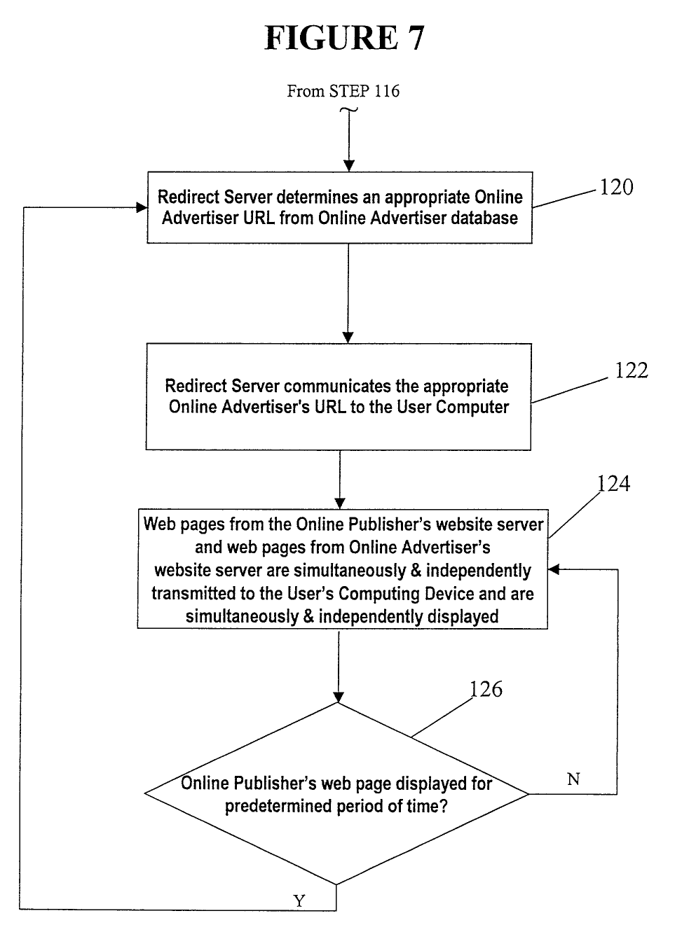

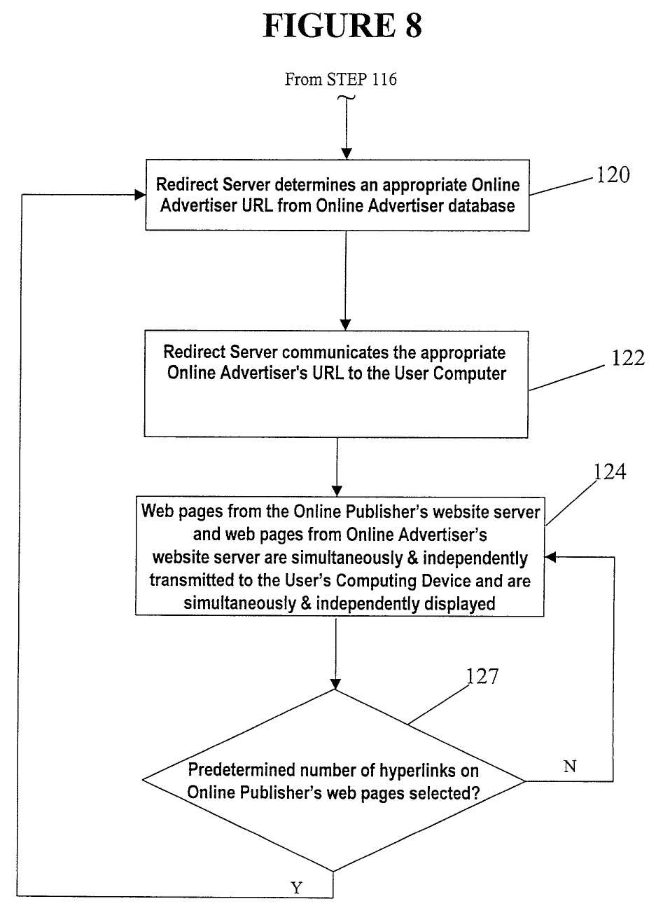

With any of the methods described and depicted in FIGS. 4, 5, and 6, once the web pages 38, 42 from the two websites are simultaneously and independently displayed, the user may, in some instances, be able to manipulate (e.g., increase or decrease) the sizes of the displayed web pages 38, 42 by “grasping” and “dragging” the divider 44 using, for example, the mouse 15. In other instances, either the online publisher or the online advertiser, or both, may have requested that such manipulations be disabled. The system and methodology will continue to operate as before, but the web pages 38, 42 will be displayed with the manipulated web page sizes. Additionally, once the web pages 38, 42 are simultaneously and independently displayed, the length of time that a particular online advertiser server 14 transmits its formatted marketing-based web pages 42 for display along with the formatted content-based web pages 38, will depend on the particular embodiment. For example, in the embodiments depicted in FIGS. 4, 5, and 6, the initially determined online advertiser server 14 will continue to transmit formatted marketing-based web pages for as long as the user computer 18 is receiving content-based web pages 38 from the same online publisher server 12. An appropriate online advertiser server 14 will be newly determined only when the user navigates to another one of the online publisher homepages 32. In another embodiment, depicted in FIG. 7, a formatted marketing-based web pages 42 is transmitted from one of the online advertiser servers 14 and is displayed on the display screen 34 with a formatted content-based web page 38 for a predetermined period of time. Once the predetermined period of time has elapsed (STEP 126), the redirect server 16 determines the URL of another appropriate online advertiser server from the advertiser database 26 (back to STEP 120), and the remaining portions of the method repeat. In yet another embodiment, depicted in FIG. 8, a formatted marketing-based web page 42 is transmitted from one of the online advertiser servers 14 and is displayed on the display screen 34 with a formatted content-based web page 38 for a predetermined number of hyperlink selections on the content-based web page 38 (STEP 127). In other words, after the user has selected a predetermined number of hyperlinks 39 on successively displayed content-based web pages 38, the redirect server 16 determines the URL of another appropriate online advertiser server from the advertiser database 26 (back to STEP 120), and the remaining portions of the method repeat.

While preferred embodiments of the present invention have been illustrated in detail, it is apparent that modifications and adaptations of the preferred embodiments will occur to those skilled in the art. For instance, in describing the hardware and software components of the system, it was repeatedly intimated that numerous and varied hardware and software components may be used to implement the present invention. This is because the specific hardware and software components that are useful in implementing the present invention are indeed numerous and varied, and will continue to be so. The present description only provides what is presently considered to be the best mode for carrying out the invention. However, it is realized that other specific hardware and software components, and combinations thereof, and modifications and adaptations thereto, which are too numerous to list, may also be used. However, it will be expressly understood that such combinations, modifications, and adaptations are within the spirit and scope of the present invention as set forth in the following claims.

We claim:

1. A method of providing web-based marketing, comprising:
providing an online publisher server computer including at least a content-based website stored in memory, the content-based website including one or more web pages that are formatted to be displayed from the online publisher server computer in a first display region of a client computer browser display screen;
providing an online advertiser server computer including a marketing-based website stored in memory, the marketing-based website including one or more web pages that are formatted to be displayed from the online advertiser server computer in a second display region of the client computer browser display screen;
transmitting a homepage of the content-based website from the online publisher server computer for display in the client computer browser display screen; and
transmitting one of the formatted web pages of the content-based website from the online publisher server computer for display in the first display region of the client computer browser display screen and simultaneously and independently transmitting one of the formatted web pages of the marketing-based website from the online advertiser server computer for simultaneous and independent display in the second display region of the client computer browser display screen, in response to a client computer user selecting a hyperlink displayed on the homepage.

2. The method of claim 1, wherein the formatted content-based web page from the online publisher server computer is associated with the selected hyperlink, and the formatted marketing-based web page from the online advertiser server computer is not associated with the selected hyperlink.

3. The method of claim 1, wherein the simultaneously and independently transmitted and displayed web pages of the content-based and marketing-based websites are each navigable independent of the other.

4. The method of claim 1, further comprising:
separating the simultaneously and independently transmitted and displayed web pages of the content-based and marketing-base websites in the client computer browser display screen by a separator.

5. The method of claim 4, wherein the separator comprises a scroll bar.

6. The method of claim 4, wherein the separator comprises a divider bar.

7. The method of claim 1, further comprising:
including personalized information in the formatted marketing-based web pages, the personalized information being based on stored data that is representative of a personal profile of the client computer user.

8. The method of claim 1, wherein the first display region includes approximately 60% of the client computer browser display screen, and the second display region includes approximately 40% of the client computer browser display screen.

9. The method of claim 1, further comprising:
communicating with the client computer;
determining whether the client computer includes data representative of a personal profile of the client computer user;
retrieving the data representative of the personal profile from the client computer, in response to the determination that the client computer includes the data; and
storing the data representative of the personal profile in a database.

10. The method of claim 9, further comprising:
transmitting data representative of the personal profile of the client computer user to memory resident in the client computer, in response to the determination that the client computer does not include the data; and
storing the data representative of the personal profile in a database.

11. A method of providing web-based marketing, comprising:
providing an online publisher server computer including at least a content-based website stored in memory, the content-based website including one or more web pages that are formatted to be displayed from the online publisher server computer in a first display region of a client computer browser display screen;
providing an online advertiser server computer including a marketing-based website stored in memory, the marketing-based website including one or more web pages that are formatted to be displayed from the online advertiser server computer in a second display region of the client computer browser display screen; and
simultaneously and independently transmitting one of the formatted more web pages of the content-based website from the online publisher server computer for display in the first display region of the client computer browser display screen and one of the formatted web pages of the marketing-based website from the online advertiser server computer for simultaneous and independent display in the second display region of the client computer browser display screen, in response to a user navigating to a URL of the content-based website.

12. The method of claim 11, wherein the URL of the content-based website is a URL associated with a homepage of the content-based website.

13. The method of claim 11, wherein the user navigates to the URL of the content-based website in response to selecting a displayed hyperlink.

14. The method of claim 13, wherein the displayed hyperlink is displayed on a web page.

15. The method of claim 13, wherein the displayed hyperlink is displayed in an email message.

16. The method of claim 11, wherein the simultaneously and independently transmitted and displayed web pages of the content-based and marketing-based websites are each navigable independent of the other.

17. The method of claim 11, further comprising:
separating the simultaneously and independently transmitted and displayed web pages of the content-based and marketing-based websites in the client computer browser display screen by a separator.

18. The method of claim 17, wherein the separator comprises a scroll bar.

19. The method of claim 17, wherein the separator comprises a divider bar.

20. The method of claim 11, further comprising:
including personalized information in the formatted web pages of the marketing-based website, the personalized information being based on stored data that is representative of a personal profile of the client computer user.

21. The method of claim 11, wherein the first display region includes approximately 60% of the client computer browser display screen, and the second display region includes approximately 40% of the client computer browser display screen.

22. The method of claim 11, further comprising:
communicating with the client computer;
determining whether the client computer includes data representative of a personal profile of the client computer user;
retrieving the data representative of the personal profile from the client computer, in response to the determination that the client computer includes the data; and
storing the data representative of the personal profile in a database.

23. The method of claim 20, further comprising:
transmitting data representative of the personal profile of the client computer user to memory resident in the client computer, in response to the determination that the client computer does not include the data; and
storing the data representative of the personal profile in a database.

24. A system for simultaneously and independently displaying a content-based web page and a marketing-based web page in a browser display screen of a client computer in communication with a distribution medium, comprising:
one or more online publisher server computers each including a website having one or more content-based web pages formatted to be displayed in a first display region of the browser display screen;
one or more online advertiser server computers each including a website having one or more marketing-based web pages formatted to be displayed in a second region of the browser display screen; and,
one or more redirect server computers in communication with the client computer via the distribution medium,
wherein, in response to a communication from the client computer, said redirect server computer directs the client computer to request one of said online advertiser server computers to simultaneously and independently transmit, via the distribution medium, one of its formatted marketing-based web pages to the client computer for simultaneous and independent display of the transmitted marketing-based web page in the second display region with a formatted content-based web page from one of said online publisher server computers in the first display region.

33. The system of claim 24, wherein the distribution medium comprises the Internet.

34. A computer implemented system for providing marketing to one or more client computers connected to an interconnected computer network, comprising:
first server computing means for (1) storing a website including one or more content-based web pages formatted to be displayed in a first display region of a client computer browser display screen and (2) transmitting the formatted content-based web pages onto the interconnected computer network;
second server computing means for (1) storing a website including one or more marketing-based web pages formatted to be displayed in a second display region of a client computer browser display screen and (2) transmitting the formatted marketing-based web pages to the interconnected computer network; and
redirection computing means, responsive to communications received from one of the client computers connected to the interconnected computer network, for directing the client computer to request said second server computing means to simultaneously and independently transmit the formatted marketing-based web pages to the client computer for simultaneous and independent display of the transmitted marketing-based web page in the second display region with a formatted content-based web page transmitted from said first server computing means for display in the first display region.

35. The system of claim 34, further comprising first database means, in communication with said redirection computing means, for storing URLs of a plurality of said marketing-based web pages.

36. The system of claim 34, further comprising second database means, in communication with said redirection computing means, for storing data representative of information about client computer users.

37. The system of claim 34, wherein the communications from one of the client computers with said redirection computing means occurs in response to a client computer user selecting a displayed hyperlink.

38. The system of claim 37, wherein the displayed hyperlink is displayed on a web page.

39. The system of claim 38, wherein the web page is a homepage of the website of one of said online publisher server computers.

40. The system of claim 37, wherein the displayed hyperlink is displayed in an e-mail message.

41. The system of claim 37, wherein the formatted and displayed content-based web page from said first server computing means is associated with the selected hyperlink, and the formatted and displayed marketing-based web page from said second server computing means is not associated with the selected hyperlink.

42. The system of claim 34, wherein the distribution medium comprises the Internet.

43. A method of simultaneously and independently displaying at a client computer browser display screen two web pages from two independent websites coupled to the client computer through a distribution network, comprising:
storing one or more web pages of a first of the two websites that are formatted to be displayed from a first server computer in a first display region of the client computer browser display screen;
storing one or more web pages of a second of the two websites that are formatted to be displayed from a second server computer in a second display region of the client computer browser display screen; and
simultaneously and independently transmitting, via the distribution medium, one of the formatted web pages from the first server computer for display in the first display region of the client computer browser display screen and one of the formatted web pages from the second server computer for display in the second display region of the client computer browser display screen, in response to one or more communications between a third server computer and the client computer.

44. The method of claim 43, wherein the first website is a content-based website and the second website is a marketing-based website.

45. The method of claim 43, wherein the simultaneously and independently transmitted and displayed web pages of the first and second websites are each navigable independent of the other.

46. The method of claim 43, further comprising:
separating the simultaneously and independently transmitted and displayed web pages of the first and second websites in the client computer browser display screen by a separator.

47. The method of claim 46, wherein the separator comprises a scroll bar.

48. The method of claim 43, further comprising:
including personalized information in the formatted web pages of the second website, the personalized information being based on stored data that is representative of a personal profile of the client computer user profile.

49. The method of claim 43, wherein the first region includes approximately 60% of the client computer browser display screen, and the second region includes approximately 40% of the client computer browser display screen.

50. The method of claim 43, further comprising:
communicating with the client computer;
determining whether the client computer includes data representative of a personal profile of the client computer user;
retrieving the data representative of the personal profile from the client computer, in response to the determination that the client computer includes the data; and
storing the data representative of the personal profile in a database.

51. The method of claim 50, further comprising:
transmitting data representative of the personal profile of the client computer user to memory resident in the client computer, in response to the determination that the client computer does not include the data; and
storing the data representative of the personal profile in a database.

52. The method of claim 43, wherein the one or more communications between the third server computer and the client computer occurs in response to the client computer user selecting a displayed hyperlink.

53. The method of claim 52, wherein the displayed hyperlink is displayed on a web page.

54. The method of claim 53, wherein the web page is a homepage of the website of one of the first server computers.

55. The method of claim 52, wherein the displayed hyperlink is displayed in an email message.

56. The method of claim 52, wherein the formatted and displayed web page from the first server computer is associated with the selected hyperlink, and the formatted and displayed web page from the second server computer is not associated with the selected hyperlink.

57. A computer-readable storage medium containing computer executable code for instructing a plurality of server computers to perform the steps of:
simultaneously and independently transmitting at least one formatted web page from a first server computer for display in a first display region of a client computer browser display screen and at least one formatted web page from a second server computer for display in a second display region of the client computer browser display screen, in response to one or more communications between a third server computer and the client computer.
